(19) United States
(12) Patent Application Publication
(10) Pub. No.: US 2006/0143412 A1
(43) Pub. Date: Jun. 29, 2006

(54) Snapshot copy facility maintaining read performance and write performance

(76) Inventor: Philippe Armangau, Acton, MA (US)

Correspondence Address: RICHARD AUCHTERLONIE;NOVAK DRUCE & QUIGG, LLP, 1000 LOUISIANA, SUITE 5320, HOUSTON, TX, 77002, US

(21) Appl. No.: 11/023,761

(22) Filed: Dec. 28, 2004

(51) Int. Cl. G06F 12/16

(52) U.S. Cl. 711/162

(57) ABSTRACT

To make a snapshot copy of a production dataset concurrent with read/write access, a record is kept of the blocks in the production dataset that have been written to since the point-in-time of the snapshot. The first write to each data block is done as a “fast write” to a non-volatile staging block resulting in an immediate acknowledgement to the application writing to the production dataset. In background, the original contents of the block in the production dataset are copied to a save block, and then the new data is copied from the staging block to the production dataset. This method maintains read and write performance because the background copy operations need not be done on the input-output data path.

### FIELD OF THE INVENTION

The present invention relates generally to data storage and backup, and more particularly to the creation of a snapshot copy of a production dataset concurrent with read-write access to the production dataset.

### BACKGROUND OF THE INVENTION

A snapshot copy of a production dataset contains the state of the production dataset at a respective point in time when the snapshot copy is created. A snapshot copy facility can create a snapshot copy without any substantial disruption to concurrent read-write access to the production dataset. Snapshot copies have been used for a variety of data processing and storage management functions such as storage backup, transaction processing, and software debugging.

There are two different well-known methods of making a snapshot copy of a production dataset. The first is called “copy on first write” and the second is called “write somewhere else.” In either method, a record is kept of whether each block of the dataset has been modified since the time of the snapshot.

In the “copy on first write” method, when writing to a block of the production dataset, the record is accessed to determine if a first write is being made to the block of the production dataset, and if so, a new block is allocated, and the original contents of the block in the production dataset are copied to the new block, before the block in the production dataset is modified by the write operation. An example of a snapshot copy facility using this method is found in Armangau et al., U.S. Pat. No. 6,792,518, incorporated herein by reference. This method does not cause a reduction in read performance for reading the production dataset because the method does not change the address from which a block is read from the production dataset. However, this method causes a reduction in the write performance.

In the “write somewhere else” method, when writing to a block of the production dataset, the record is accessed to determine if a first write is being made to the production dataset, and if so, a new block is allocated, and the new data is written to the new block. This method maintains the write performance at a slightly reduced level. However, the read performance degrades over time because of the changing addresses from which the data are read from the production dataset.

### SUMMARY OF THE INVENTION

It is desired to get the advantages of both of the above-described methods, without the inconvenience of either method. This can be done by doing the first write of each new data block since the point in time of the snapshot to a non-volatile staging block so that the write operation is acknowledged to the requesting application before the new data block is written to the production dataset. In background, the original contents of the block in the production dataset are copied to a save block, and then the new data block is copied from the staging block to the production dataset. The read and write performance need not degrade because the background copy operations need not be on the input-output data path.

Performance can be improved further by doing a “fast write” in cache memory, and doing the background copy operation by sending disk copy commands to back-end storage. For a production dataset stored in a redundant disk array, the background copy could be a back-end disk-to-disk copy operation to a save block in the disk array in which the read of the original block in the production dataset is concurrent with the read of original data and associated parity from the save block.

In accordance with one aspect, the invention provides a method of creating a snapshot copy of a production dataset concurrent with read-write access to the production dataset. The snapshot copy is the state of the production dataset at a certain point in time. The method includes keeping a record of blocks of the production dataset that have been modified since the point in time, and responding to a request for write access to a specified block in the production dataset by checking the record of blocks of the production dataset that have been modified since the point in time. The method further includes, upon finding that the specified block in the production dataset has not been modified since the point in time, writing new data for the specified block to a non-volatile staging block and returning an acknowledgement of the write operation, and thereafter copying original data from the specified block of the production dataset to a save block, and then copying the new data for the specified block from the staging block to the production dataset.

In accordance with another aspect, the invention provides a method of operating a server for creating a snapshot copy of a production dataset concurrent with read-write client access to the production dataset. The snapshot copy is the state of the production dataset at a certain point in time. The method includes keeping a record of blocks of the production dataset that have been modified since the point in time, and responding to a request from a client for write access to a specified block in the production dataset by checking the record of blocks of the production dataset that have been modified since the point in time. The method further includes, upon finding that the specified block in the production dataset has not been modified since the point in time, allocating a block of non-volatile memory to the specified block and writing new data for the specified block from the client to the allocated block of non-volatile memory and returning an acknowledgement of completion of the write operation to the client, and thereafter a background copy process copying original data from the specified block of the production dataset to a save block allocated to the specified block and then initiating a block staging task for copying the new data for the specified block from the allocated block of non-volatile memory to the production dataset.

In accordance with yet another aspect, the invention provides a server having storage for storing a production dataset, and at least one processor for creating a snapshot copy of a production dataset concurrent with read-write client access to the production dataset. The snapshot copy is the state of the production dataset at a certain point in time. The at least one processor is programmed for keeping a record of blocks of the production dataset that have been modified since the point in time, and responding to a request from a client for write access to a specified block in the production dataset by checking the record of blocks of the production dataset that have been modified since the point in time. The at least one processor is also programmed for, upon finding that the specified block in the production dataset has not been modified since the point in time, allocating a block of non-volatile memory to the specified block and writing new data for the specified block from the client to the allocated block of non-volatile memory and returning an acknowledgement of completion of the write operation to the client, and thereafter a background copy process copying original data from the specified block of the production dataset to a save block allocated to the specified block and then initiating a block staging task for copying the new data for the specified block from the allocated block of non-volatile memory to the production dataset.

### BRIEF DESCRIPTION OF THE DRAWINGS

Additional features and advantages of the invention will be described below with reference to the drawings, in which:

FIG. 1 is a block diagram of a data network including a network server programmed in accordance with a first embodiment of the present invention for providing data storage and snapshot copy service to network clients;

FIG. 2 is a schematic diagram of data structures and data flow used by a preferred implementation of the snapshot copy facility of the present invention;

FIG. 3 shows an example of a block map introduced in FIG. 2;

FIG. 4 is a simplified flowchart of programming for the snapshot copy facility in order to produce the data flow shown in FIG. 2;

FIG. 5 is a state diagram for a specific example of programming shown in FIGS. 6 to 11 for the snapshot copy facility;

FIG. 6 is a flowchart of a procedure for writing a specified block to a production dataset;

FIG. 7 is a flowchart of a background copy thread;

FIG. 8 is a flowchart of a block staging task;

FIG. 9 is a flowchart of a procedure for creating a new snapshot;

FIG. 10 is a flowchart of a procedure for reading a specified block from a snapshot dataset;

FIG. 11 is a flowchart of a procedure for reading a specified block from the production dataset; and

FIG. 12 is a block diagram of a data network including a network server programmed in accordance with a second embodiment of the present invention for providing data storage and snapshot copy service to network clients.

While the invention is susceptible to various modifications and alternative forms, specific embodiments thereof have been shown in the drawings and will be described in detail. It should be understood, however, that it is not intended to limit the invention to the particular forms shown, but on the contrary, the intention is to cover all modifications, equivalents, and alternatives falling within the scope of the invention as defined by the appended claims.

### DETAILED DESCRIPTION OF THE PREFERRED EMBODIMENT

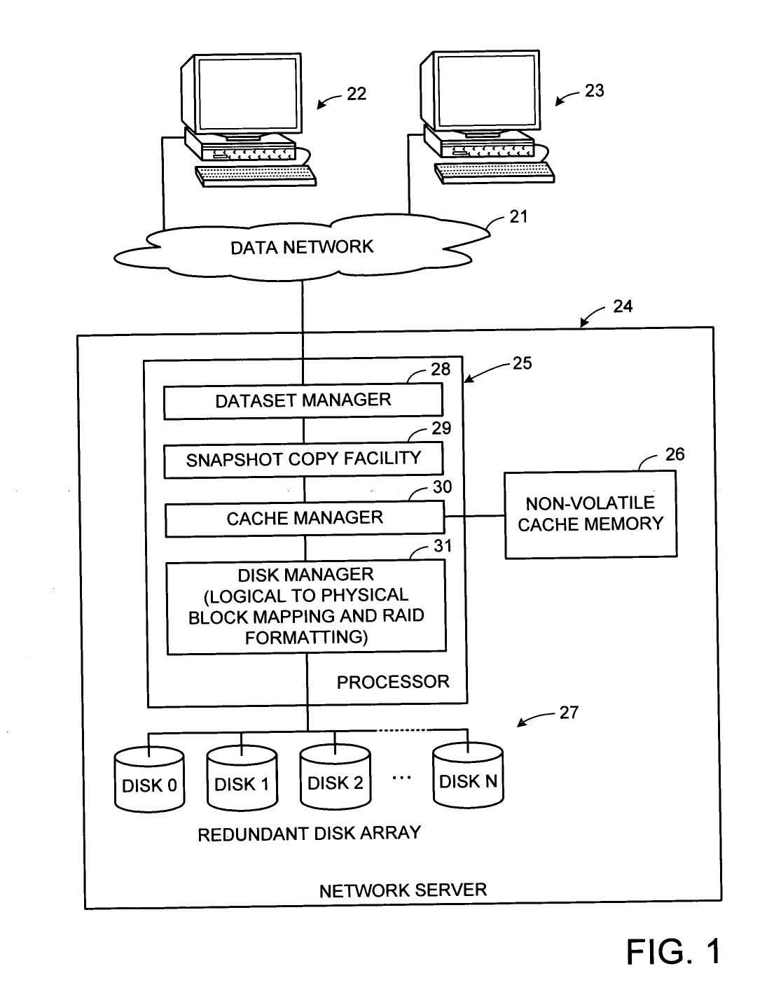

With reference to FIG. 1, there is shown a data processing system incorporating the present invention. The data processing system includes a data network 21 interconnecting a number of clients 22, 23, to a network server 24 providing storage and snapshot copy service. The clients 22, 23, for example, are workstations such as personal computers using either UNIX or Microsoft Windows operating systems.

The network server 24 includes at least one processor 25, non-volatile cache memory 26, and a redundant disk array 27 for mass data storage. The non-volatile ache memory 26, for example, is a dual-redundant battery-backed static random access memory (RAM).

The processor 25 is programmed with a dataset manager 28, a snapshot copy facility 29, a cache manager 30, and a disk manager 31. The dataset manager 28 organizes logical blocks of storage into datasets such as volumes, files, or tables, and controls access of the clients to the datasets. The snapshot copy facility 29 creates a snapshot copy of a specified production dataset concurrent with read-write access to the production dataset. The cache manager 30 maintains a copy of recently accessed data blocks in the non-volatile cache memory 26, and an index to the data blocks presently contained in the cache memory. The disk manager 31 maintains a mapping of logical blocks to physical blocks on the disks in the redundant disk array 27 and performs the formatting or striping of data blocks and parity blocks in accordance with a desired level of redundancy (i.e., a desired RAID level).

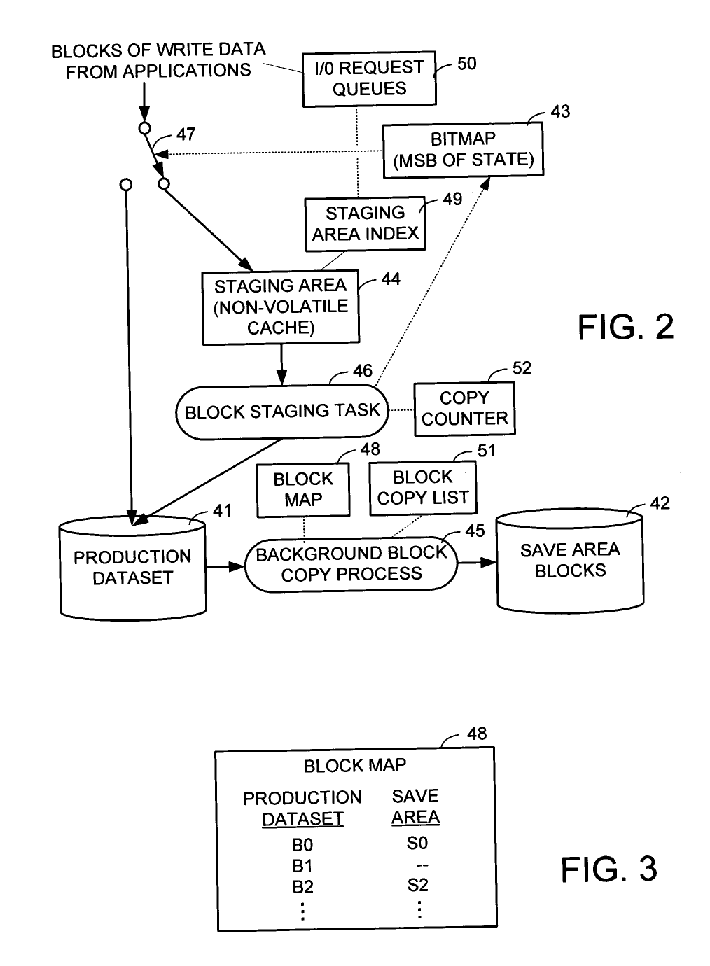

The present invention concerns the programming and operation of the snapshot copy facility 29 in order to maintain read and write performance concurrent with creation of a snapshot. For example, the snapshot copy facility is programmed to produce the data flow as shown in FIG. 2 between various data structures in the server of FIG. 1.

With reference to FIG. 2, a snapshot copy facility employing a “copy on first write” method creates a snapshot copy of a production data set 41 by responding to an application request to write to a specified block by first copying original data from the block in the production dataset to a block in a save area 42, setting a bit for the block in a bitmap 43 upon completion of the block copy, and then writing to the block in the production dataset. Such a “copy on first write” method has a reduction in write performance because writing of the new block is delayed until the original block is copied from the production dataset 41 to the save area 42.

As further shown in FIG. 2, the reduction in write performance is eliminated by a “fast write” to a staging area 44 in non-volatile memory, resulting in an immediate acknowledgement to the application writing to the production dataset. The non-volatile memory could be battery-backed random access memory, or it could be disk storage. For the network server as shown in FIG. 1, for example, the staging area 44 is comprised of reserved or pinned blocks of the non-volatile cache memory 26. A background block copy process 45 copies the original contents of the specified block in the production dataset 41 to a block in the save area 42, and then a block staging task 48 writes the new data for the specified block from the staging area 44 to the production dataset 41. The read and write performance does not degrade because the background copy operations are not on the input-output data path.

Once a first new block has been written to the production dataset 41 since the point in time of the snapshot, a corresponding bit in the bitmap 43 is set to indicate that additional writes to the specified block are directed to the production dataset instead of the staging area 44, as shown by the switch 47.

To conserve storage for the save area, free blocks in the save area can be dynamically allocated as needed to receive the copied data from the production dataset 41. In this case, the mapping of the logical block addresses between the production dataset 41 and the save area 42 is stored in a block map 44, which is further shown in FIG. 3.

In a similar fashion, blocks in the staging area 44 are also dynamically allocated, and a staging area index 49 indicates which blocks are presently stored in the staging area. The staging area index, for example, includes a hash table and hash lists in a fashion similar to a cache index in a cached disk storage system. Alternatively, the staging area may be created by dynamically allocating and pinning cache blocks of the cache in a cached disk storage system, in which case the staging index 49 may use otherwise unused bits in the cache block attributes provided in the cache index for such a cached disk array. For example, the staging area index 49 includes bits associated with each block in the staging area for indicating the state of the snapshot creation process for the block. Alternatively, a set of bitmaps could be used to store the snapshot state associated with each block of the production dataset. For example, one bitmap could indicate whether or not any new data is in a save block allocated for each block of the production dataset, another bitmap could indicate whether or not an I/O is in progress to any save block for each block in the production dataset, and still another bitmap could indicate whether or not a block staging task is in progress for each block of the production dataset.

Also shown in FIG. 2 are I/O request queues for queuing I/O requests to blocks in the staging area when a request cannot be immediately serviced due to pending reads or writes to the staging area 44 or due to the block staging task 46. These I/O request queues can also be dynamically allocated to respective blocks in the staging area. For example, each block in the staging area 44 has an I/O queue pointer that is either zero indicating an empty or non-existent I/O queue, or else points to an I/O queue for the block.

Further shown in FIG. 2 is a block copy list 51 serviced by the background copy process 45, and a copy counter 52. When a new snapshot is created, the block copy list 51 is empty and the copy counter is zero. When a block in the staging area 44 is first allocated and receives new data since the point in time of the snapshot, the corresponding block index (Bi) is inserted onto the block copy list 51, and also the copy counter 52 is incremented. The background copy process successively removes block indices from the block copy list and copies original data for these blocks from the production data set 41 to the save area 42. Once a block is copied from the production dataset to the save area, a block staging task for the block is initiated. The block staging task copies the new data from the staging area 44 to the production data set 41, de-allocates the block from the staging area, and then decrements the copy counter. In this fashion, the copy counter indicates the number of blocks of new data in the staging area 44 that have not yet been copied to the production data set 41.

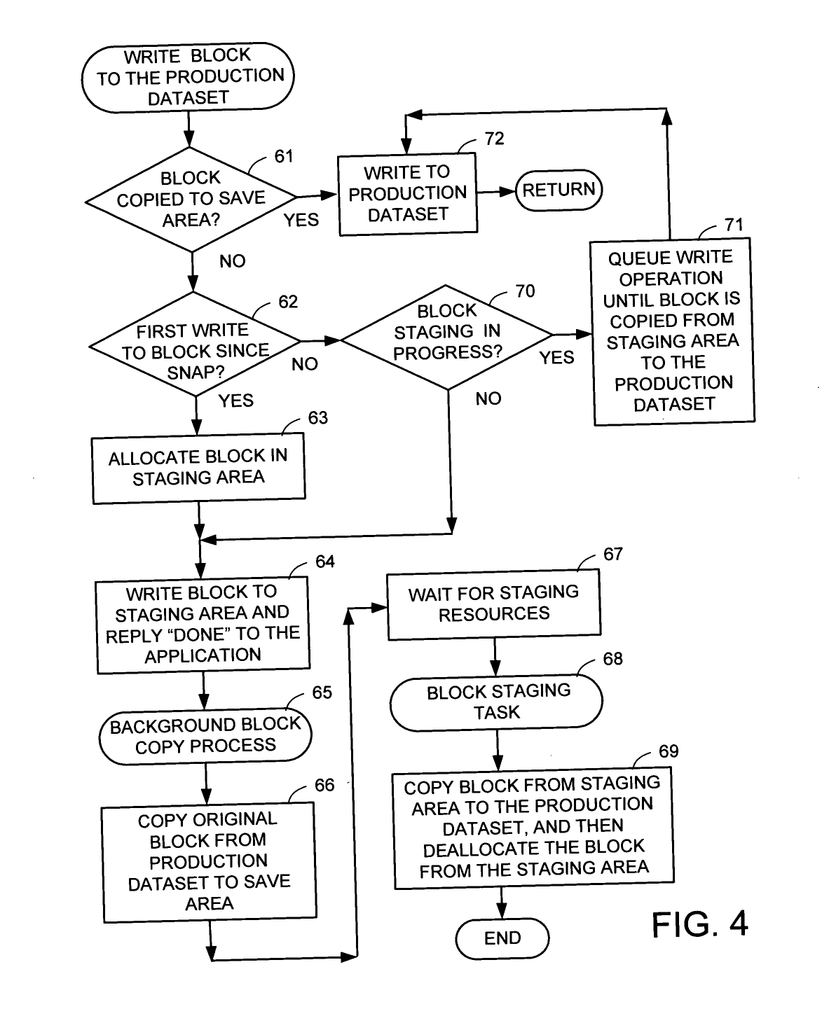

FIG. 4 shows generally the snapshot copy creation process in response to one or more writes to the same block in the production dataset. In a first step 61, if the block has not yet been copied from the production dataset to the save area, then execution continues to step 62. In step 62, if the write is the first write to the block since the snapshot creation time, then execution continues to step 63. In step 63, a block of memory is allocated in the staging area. In step 64, the new block of data is written to the allocated block of memory in the staging area, and an acknowledgment of completion of the write operation is returned to the client application having requested the write operation. In step 65, the background copy process is initiated. In step 66, in the background copy process, the original data of the block is copied from the production dataset to the save area. In step 67, execution waits for any pending read or write operations upon the block before beginning the block staging task in step 68. Once staging resources are available, the block staging task is performed in step 69 by copying the new block from the staging area to the production dataset, and then the block is de-allocated from the staging area.

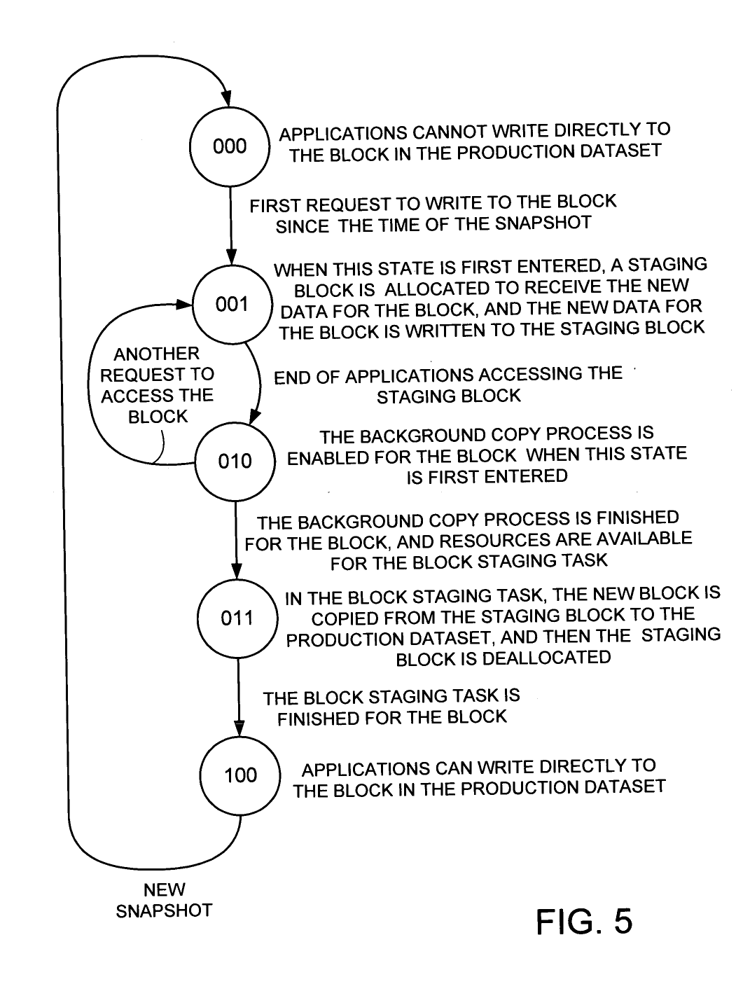

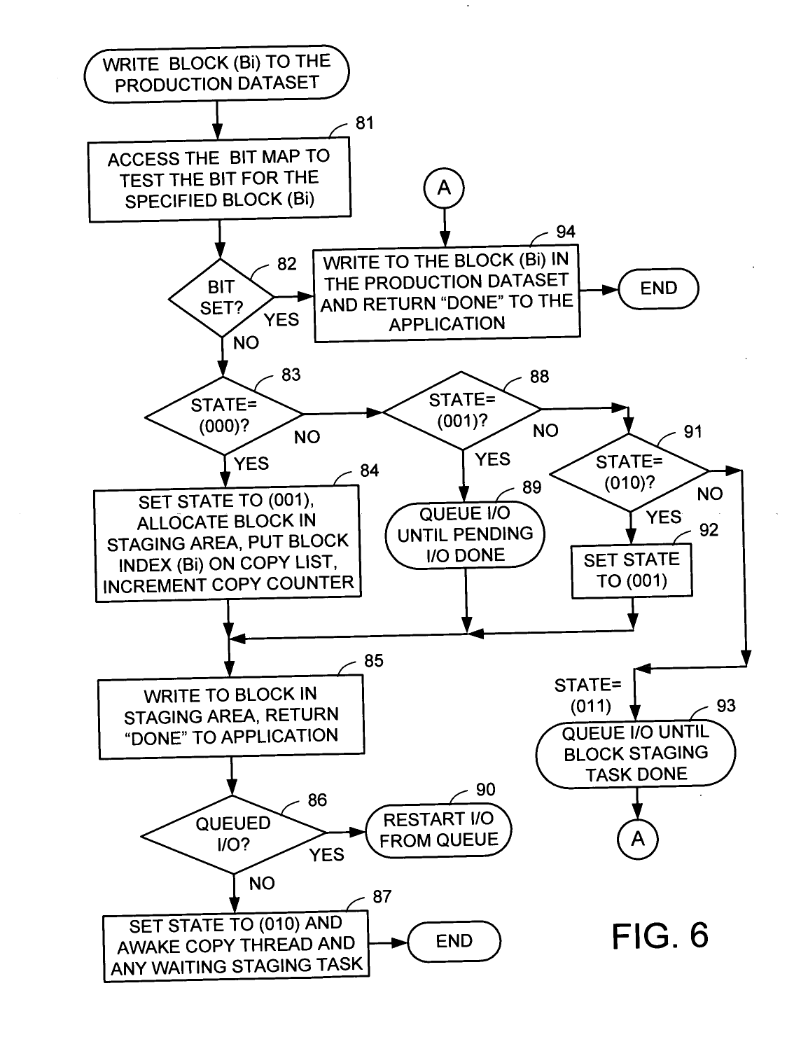

FIG. 5 is a state diagram for a specific example of programming shown in FIGS. 6 to 11 for the snapshot copy facility. In this example, the snapshot copy facility has five possible states for each block in a production dataset. These five possible states are encoded into three bits, the most significant of which is the respective bit for the block in the bitmap for the production dataset.

When a new snapshot is taken, a pointer is switched to replace the original bitmap with a reset bitmap, and also all of the staging area blocks are de-allocated. In this situation, the initial state for each of the blocks is (000). In this state, the client applications cannot write directly to the block in the production dataset. Upon receipt of the first request to write to a block since the point-in-time of the snapshot, the state for the block is changed to state (001).

When state (001) is first entered, a block of non-volatile memory is allocated in the staging area to receive the new block from the application, and the new block is written to the staging block. When applications are no longer accessing the block in the staging area, the state for the block is changed to state (010). When state (010) is first entered, the background copy process is enabled for the block. From state (010), if a request is received to read or write to the block, then the state is changed back to (001). From state (010), the state is changed to (011) when the background copy process is finished for the block, and resources are available for the staging task for the block. In state (011), the staging task is performed by copying the new data from the staging block to the production dataset, and then the staging block is de-allocated. When the staging task is finished for the block, the state is changed to (100). In state (100), the client applications can write directly to the block in the production dataset.

FIG. 6 shows a procedure for writing new data to a specified block (Bi) in the production dataset. In a first step 81, the snapshot copy manager accesses the bit map to test the respective bit for the specified block. In step 82, if the respective bit is not set, then execution continues to step 83. In step 83, if the snapshot copy state for the specified block is (000), then execution continues to step 84. For example, in step 83, the snapshot copy manager accesses the staging area index (49 in FIG. 3), and upon finding that an entry for the specified block is absent from the staging area index, the snapshot copy manager concludes that the state for the specified block is (000).

In step 84, the snapshot copy manager sets the state for the block to (001) by putting an entry for the block into the staging area index, and allocates a block in the staging area, and puts the block index (Bi) on a copy list, and increments a copy counter. As described further below, the copy list is used as a work queue for the background copy process, and the copy counter is used for determining when the block staging task has been completed for all staging blocks. In step 85, the snapshot copy manager writes to the allocated staging block, and returns a “fast write” acknowledgement, to the application, indicating that the write operation is “done.” In step 86, if there is a queued I/O operation waiting for access to the staging block, then execution branches to step 90 to restart the I/O from the queue. In step 86, if there is not a queued I/O operation waiting for access to the staging block, then execution continues to step 87. In step 87, the snapshot copy manager sets the state for the block to (010) and awakes the thread for the background copy process and any waiting block staging task. At this point, the snapshot copy process is finished with the write I/O operation upon the block.

In step 83, if the specified block is found in the staging area (i.e., the state for the block is not (000)) then execution continues to step 88. If the state for the block is (001) (i.e., an I/O operation is in progress upon the block in the staging area), then execution continues to step 89 to queue the I/O request until the pending I/O is done. Once the pending I/O is done, execution continues from step 89 to step 85 to perform the queued write operation upon the staging block.

In step 88, if the state for the block is not (001), then execution continues to step 91. In step 91, if the state for the block is (010), then execution continues to step 92. In step 92, the snapshot copy manager sets the state for the block to (001), and then execution continues to step 85 to perform the write operation upon the block in the staging area.

In step 91, if the state is not (001), then execution continues step 93. At this point, the state is (011) (i.e., the block staging task is being performed for the block). Therefore, in step 93, the requested write operation is queued until the block staging task is done. Once the block staging task is done, execution continues to step 94. In step 94, the requested write operation is performed by writing to the block (Bi) in the production dataset, and returning an acknowledgement, to the application, indicating that the write operation is “done.” At this point, the snapshot copy process is finished with the write I/O operation upon the block.

In step 82, if the respective bit is set in the bit map, then execution branches to step 94 to finish the write operation by writing to the block (Bi) in the production dataset, and returning an acknowledgement, to the application, indicating that the write operation is “done.”

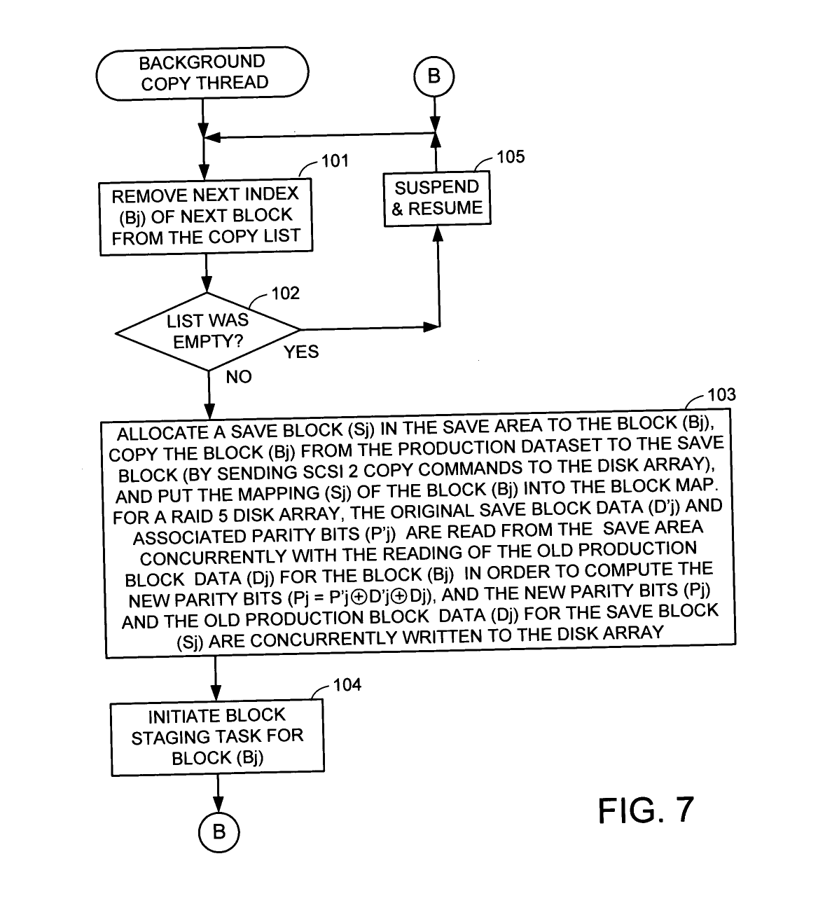

FIG. 7 shows a background copy thread. In a first step 101, the block copy list is accessed in order to remove an index (Bj) of a next block from the list. In step 102, if the list was not found to be empty, then execution continues to step 103. In step 103, a block (Sj) in the save area is allocated to the block (Bj), and the block (Bj) is copied from the production dataset to the allocated save block (Sj), for example, by sending SCSI 2 copy commands to the disk array. The mapping of the save block address (Sj) to the production dataset block address (Bj) is put into the block map. For a RAID 5 disk array, the original data (D′j) in the save block (Sj) and corresponding parity bits (P′j) associated with the original data (D′j) in the save block (Sj) are read from the save area concurrently with the reading of the old data (Dj) for the block (Bj) from the production dataset in order to compute the new parity pits (Pj=P′j XOR D′j XOR Dj) for the save block (Sj). Then the new parity pits (Pj) and the old data (Dj) to be written to the save block (Sj) are concurrently written to the save area of the disk array. In step 104, a block staging task is initiated for the block (Bj). Execution loops back from step 104 to step 101.

If the block copy list is found to be empty in step 102, execution branches to step 105. In step 105, the background copy thread is suspended until a block index is placed on the block copy list.

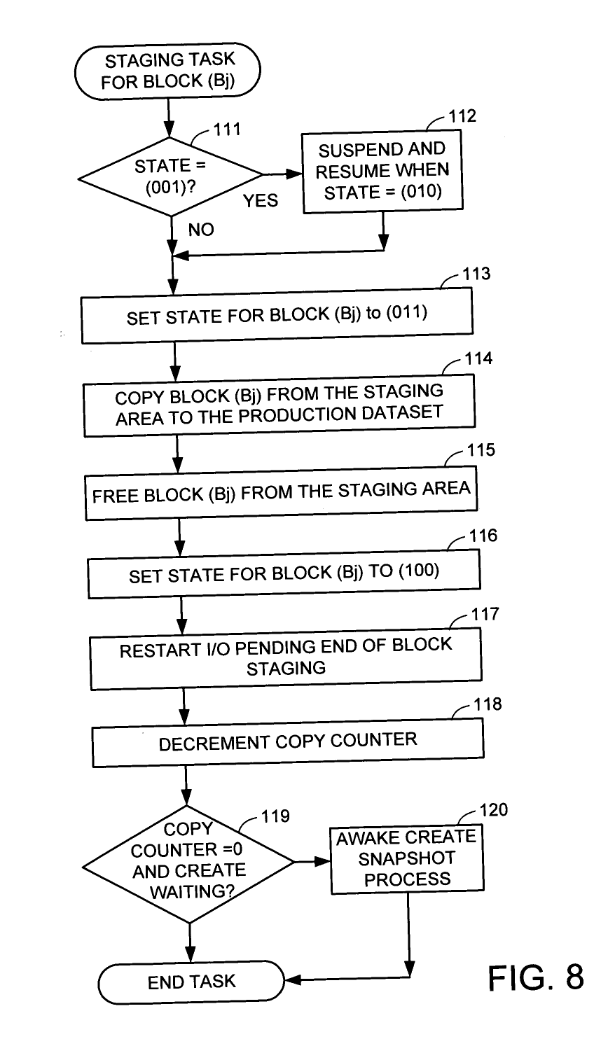

FIG. 8 shows the staging task for the block (Bj). In a first step 111, if the state for the block (Bj) is (001) (i.e., an I/O operation is pending to the block (Bj)), then execution branches to step 112 to suspend the staging task for the block (Bj) until completion of all of the pending I/O's to the block. This could be done by setting a “block copy done, block staging waiting” bit in the entry for the block in the staging area index, and then suspending the block staging task, and resuming the block staging task (in step 87 of FIG. 6) upon finding that the bit is in a set state once all pending I/O to the block is finished. Alternatively, the block staging task could be suspended after putting an entry into the I/O request queue for the block indicating that the block staging task should be resumed once the pending I/O to the block in the staging area is finished. Once the staging task for the block is resumed, execution continues from step 112 to step 113. Execution also continues from step 111 to step 113 when the state for the block (Bj) is (001).

In step 113, the state for the block (Bj) is set to (011) to indicate that the block staging task is in progress. Block staging is performed in step 114 by copying the block (Bj) from the staging area to the production dataset. In step 115, the block (Bj) is freed from the staging area. In step 116 the state for the block (Bj) is set to (100) by setting the respective bit for the block in the bitmap. Then in step 117 any I/O pending the end of block staging is restarted. In step 118, the copy counter for the production dataset is decremented. In step 119, if the copy counter is zero and a “create new snapshot” process is waiting, then execution branches to step 120 to awake the create new snapshot process. After step 120, the block staging task is finished for the block (Bj). If in step 119 the copy counter is not zero, then the block copy task is also finished for the block (Bj).

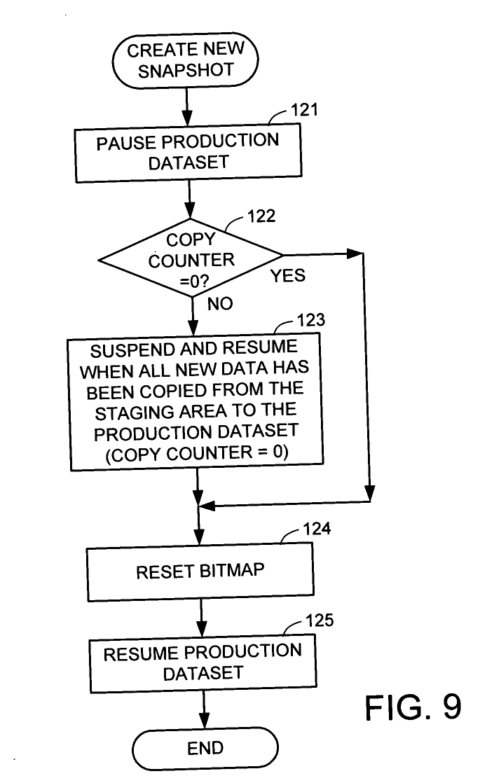

FIG. 9 shows the procedure for creating a new snapshot. In a first step 121, the production dataset is paused by suspending access to the production dataset. The new snapshot copy will become the state of the production dataset upon completion of all pending write I/O to the production dataset. In step 122, if the copy counter is not zero (i.e., the block staging task is pending for one or more blocks having been written into the staging area), execution continues to step 123 to suspend the new snapshot creation task and resume once the block staging task has been completed for all pending staging blocks (as indicated by the copy counter being decremented to zero). When the copy counter is zero, execution branches or continues to step 124 from either step 122 or step 123. In step 124, the entire bitmap for the production dataset is reset. For example, in step 124 a pointer is switched to replace the bitmap previously used with a new bit map that had been cleared during a background operation, and the bitmap that was previously used can be kept in a queue of previously used bitmaps in order to keep a time-ordered sequence of snapshot copies of the production dataset, for example, as described in the above-cited Armangau U.S. Pat. No. 6,792,518. Upon resuming access to the production dataset in step 125, the snapshot copy creation process is finished.

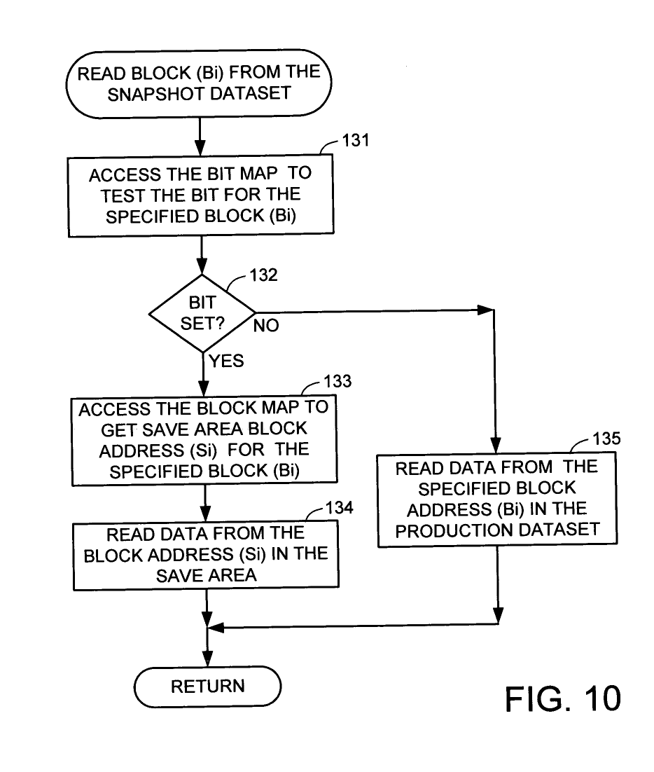

FIG. 10 shows a procedure for reading a specified block (Bi) from a snapshot dataset. In a first step 131, the bit map is accessed to test the respective bit for the specified block (Bi). In step 132, if the respective bit is set, then execution continues to step 133. In step 133, the block map is accessed to get the save area block address (Si) for the specified block (Bi). In step 134, data is read from the block address (Si) in the save area, and the data is returned to the application requesting the snapshot data.

In step 132, if the respective bit is not set, then execution branches from step 132 to step 135 to read data from the specified block address (Bi) in the production dataset, and the data is returned to the application requesting the snapshot data.

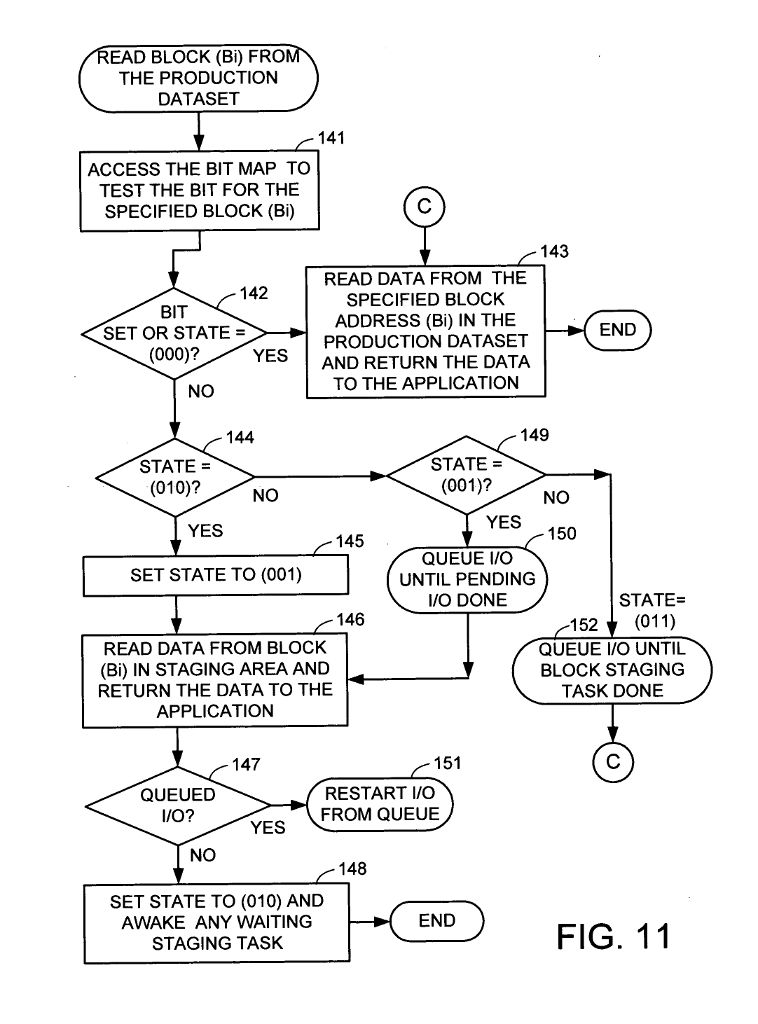

FIG. 11 shows a procedure for reading a specified block (Bi) from the production dataset. In a first step 141, the bit map is accessed to test the respective bit for the specified block (Bi). In step 142, if the respective bit is not set in the bitmap and the snapshot state for the specified block is not (000)(i.e., new production data for the specified block is present in the staging area), then execution continues from step 142 to step 144. In step 144, if the snapshot state for the specified block is (010), then execution continues from step 144 to step 145 to set the snapshot state for the specified block to (001). In step 146, data is read from the block (Bi) in the staging area, and the data is returned to the application. In step 147, if there is a pending I/O request in the I/O request queue for the block (Bi), then execution branches to step 151 to restart the next I/O operation from the queue. Otherwise, execution continues from step 147 to step 148. In step 148, the state for the block (Bi) is set to (010) and any waiting staging task for the block (Bi) is awoken, and the procedure for reading the block (Bi) from the production dataset is finished.

In step 144, if the state for the block (Bi) is not (010), then execution continues to step 149. In step 149, if the state for the block (Bi) is (001)(i.e., an I/O operation is already in progress upon the specified block in the staging area), then execution continues to step 150 to put, into the I/O request queue for the block (Bi), the present request to read the block (Bi) from the production dataset. When the I/O operation already in progress and any prior requests in the I/O request queue for the block (Bi) have completed, then execution continues from step 150 to step 146 in order to perform the requested read of the block (Bi) from the production dataset.

In step 149, if the state for the block (Bi) is not (001), then execution branches from step 149 to step 152. At this point, the state for the block (Bi) is (011)(i.e., staging is pending), and therefore in step 152 the present request to read the block (Bi) from the production dataset is put into the I/O request queue for the block (Bi). Once the staging of the block (Bi) is finished, execution continues from step 152 to step 143. In step 143, data is read from the specified block address (Bi) in the production dataset, and the data is returned to the application having requested the data, and the procedure is finished.

In step 142, if the respective bit for the block (Bi) is set in the bitmap or if the snapshot state for the block is (000)(i.e., there is no new production data in the staging area), then execution branches from step 142 to step 143 in order to read the requested data from the block address (Bi) in the production dataset and to return the data to the application having requested the data.

In step 143 there may be a possibility of permitting a write to the block concurrent with the read of the block. Data consistency in this situation can be ensured by various techniques. For example, a read or write to a disk block is typically an atomic operation, so that data consistency typically would be ensured if the logical block size is the same as the disk block size. If the logical block size is a multiple of the disk block size, then the disk manager may ensure data consistency by serializing reads and writes to the same logical block of the production dataset, for example, by keeping a bitmap or hash index of production dataset blocks having a read or write in progress and suspending another read or write to a block having a read or write in progress. It is also possible, however, that no means are provided by the disk manager to ensure read-write data consistency, so that the application would be expected to serialize reads and writes to the same block. In this case, if the snapshot state in step 142 is (000), then to ensure data consistency, step 143 could read data from the specified block (Bi) into a buffer, and before returning the contents of the buffer to the application, step 143 could check whether the state for the block has changed from (000) (due to a concurrent write to the block), and if so, then the read operation could be restarted.

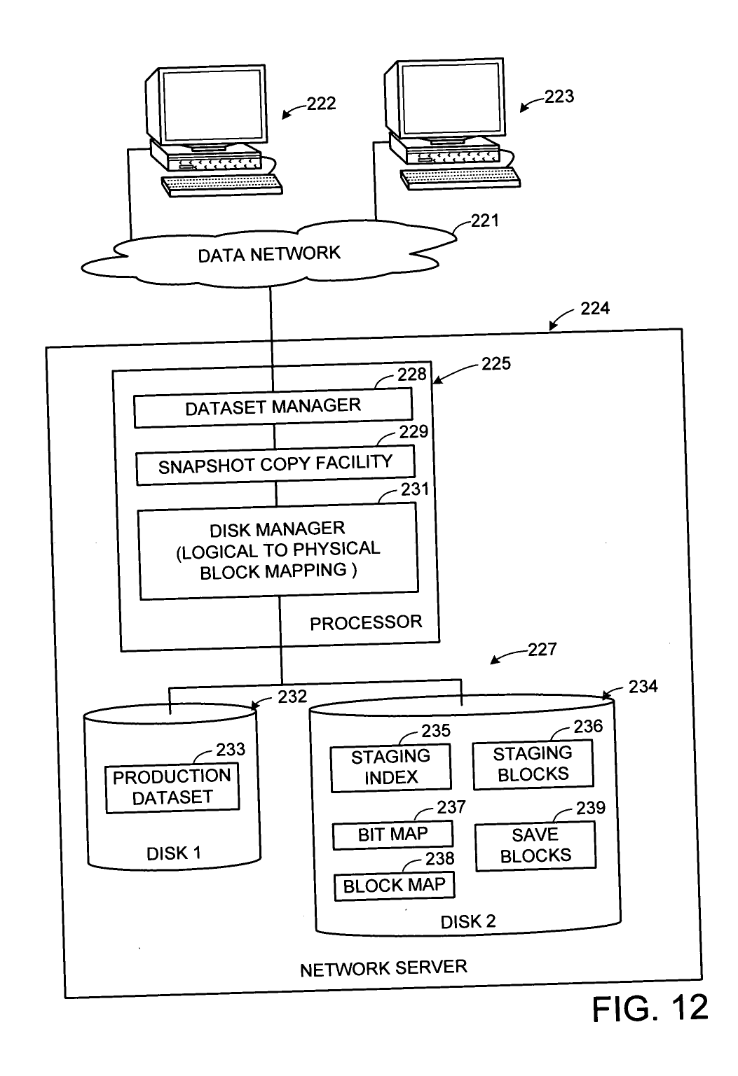

FIG. 12 shows a data network including a network server programmed in accordance with a second embodiment of the present invention for providing data storage and snapshot copy service to network clients. In this example, a data network 221 connects network clients 222 and 223 to the network server 224. The network server 224 has a processor 225 providing access to disk storage 227. The processor is programmed with a dataset manager 228, a snapshot copy facility 229, and a disk manager 231. In this example, the disk storage 227 includes a first disk drive 232 storing the production dataset 233, and a second disk drive storing a staging index 235, the staging blocks 236, a bit map 237, a block map 238, and save blocks 239. The staging blocks 236 and save blocks 239 can not only share the same disk but they can be dynamically allocated so as to be interspersed within the same logical volume stored on the second disk drive 234. The storage configuration of FIG. 12 provides an efficient allocation of limited storage resources in a small network server, and efficient use of processor resources because the background copy process and the block staging task can be performed by issuing SCSI 2 disk-to-disk copy commands to the disk storage 227.

The disk storage in the network server of FIG. 12 could be a redundant disk array. In this case, both the background copy process and the block staging task could include reading the data to be copied concurrent with reading old data and original parity associated with the old data. In other words, the background copy process would include reading original data from a block of the production dataset concurrent with reading original data from a corresponding save block and reading original parity associated with the original data read from the corresponding save block. The staging task would include reading original data from a staging block concurrent with reading original data from a corresponding block of the production dataset and original parity associated with the original data read from the corresponding block of the production dataset.

In view of the above, there has been described a method of making a snapshot copy of a production dataset concurrent with read/write access to the production dataset. A record is kept of the blocks in the production dataset that have been written to since the point-in-time of the snapshot. The first write to each data block is done as a “fast write” to a non-volatile staging block resulting in an immediate acknowledgement to the application writing to the production dataset. In background, the original contents of the block in the production dataset are copied to a save block, and then the new data is copied from the staging block to the production dataset. This method maintains read and write performance because the background copy operations need not be done on the input-output data path. At least the background copy operations can be done by disk-to-disk transfers initiated by SCSI 2 copy commands sent to back-end storage. The back end storage can be a redundant disk array in which reading of original data from a block in the production dataset is done concurrently with the reading of original data from the save block and associated parity. The staging blocks can be dynamically allocated and pinned blocks in the non-volatile cache of a cached disk array.

What is claimed is:

1. A method of creating a snapshot copy of a production dataset concurrent with read-write access to the production dataset, the snapshot copy being the state of the production dataset at a certain point in time, the method comprising:
(a) keeping a record of blocks of the production dataset that have been modified since said point in time; and
(b) responding to a request for write access to a specified block in the production dataset by checking said record of blocks of the production dataset that have been modified since said point in time and finding that the specified block in the production dataset has not been modified since said point in time, and upon finding that the specified block in the production dataset has not been modified since said point in time, writing new data for the specified block to a non-volatile staging block and returning an acknowledgement of the write operation, and thereafter copying original data from the specified block of the production dataset to a save block, and then copying the new data for the specified block from the staging block to the production dataset.

2. The method as claimed in claim 1, wherein the staging block is a dynamically-allocated block of cache memory.

3. The method as claimed in claim 1, wherein the staging block is a block of disk storage.

4. The method as claimed in claim 1, wherein the production dataset is stored in a first disk drive, and the staging block and the save block are dynamically allocated storage blocks in a second disk drive.

5. The method as claimed in claim 1, which includes queuing another request for write access to the specified block in a respective queue for the specified block when the new data for the specified block is being written to the staging block.

6. The method as claimed in claim 1, wherein the specified block of the production dataset and the save block are stored in disk storage, and the copying of the original data from the specified block of the production dataset to the save block is initiated by sending a disk copy command to the disk storage.

7. The method as claimed in claim 1, wherein the specified block of the production dataset and the save block are stored in disk storage of a redundant disk array, and the copying of original data from the specified block of the production dataset to the save block includes reading the original data from the specified block of the production dataset concurrent with reading original data from the save block and reading original parity associated with the original data read from the save block.

8. The method as claimed in claim 1, wherein the copying of the original data from the specified block of the production dataset to the save block is performed by a background copy process.

9. The method as claimed in claim 8, wherein the background copy process services a list of blocks to be copied.

10. The method as claimed in claim 8, wherein the background copy process initiates a block staging task for the specified block after copying the original data from the specified block of the production dataset to the save block, the block staging task for the specified block performing the copying of the new data for the specified block from the staging block to the production dataset.

11. The method as claimed in claim 10, which includes deferring the block staging task for the specified block when the staging block is being accessed in response to another request for write access to the specified block at the time of completion of the copying of the original data from the specified block of the production dataset to the save block, the block staging task being deferred until the staging block is no longer being accessed in response to another request for write access to the specified block.

12. The method as claimed in claimed in claim 1, which includes activating a copy counter each time that new data is first received for a first write to any block of the production dataset since said point in time, and activating the copy counter when the block staging task copies new data for any block of the production dataset to the production dataset, and deferring the creation of a new snapshot copy of the production dataset upon inspecting the copy counter and finding that the copy counter indicates that at least one block of new data has been received for writing to any block of the production dataset since said point in time and has not yet been written to the production dataset.

13. A method of operating a server for creating a snapshot copy of a production dataset concurrent with read-write client access to the production dataset, the snapshot copy being the state of the production dataset at a certain point in time, the method comprising:
(a) keeping a record of blocks of the production dataset that have been modified since said point in time; and
(b) responding to a request from a client for write access to a specified block in the production dataset by checking said record of blocks of the production dataset that have been modified since said point in time and finding that the specified block in the production dataset has not been modified since said point in time, and upon finding that the specified block in the production dataset has not been modified since said point in time, allocating a block of non-volatile memory to the specified block and writing new data for the specified block from the client to the allocated block of non-volatile memory and returning an acknowledgement of completion of the write operation to the client, and thereafter a background copy process copying original data from the specified block of the production dataset to a save block allocated to the specified block and then initiating a block staging task for copying the new data for the specified block from the allocated block of non-volatile memory to the production dataset.

14. The method as claimed in claim 13, which includes queuing another client request for write access to the specified block in a respective queue for the specified block when the new data for the specified block is being written to the allocated block of non-volatile memory.

15. The method as claimed in claim 13, wherein the specified block of the production dataset and the save block are stored in disk storage, and the copying of the original data from the specified block of the production dataset to the save block is initiated by sending a disk copy command to the disk storage.

16. The method as claimed in claim 13, wherein the specified block of the production dataset and the save block are stored in disk storage of a redundant disk array, and the copying of original data from the specified block of the production dataset to the save block includes reading the original data from the specified block of the production dataset concurrent with reading original data from the save block and reading original parity associated with the original data read from the save block.

17. The method as claimed in claim 13, which includes deferring the block staging task for the specified block when the allocated block of non-volatile memory is being accessed in response to another client request for write access to the specified bock at the time of completion of the copying of the original data from the specified block of the production dataset to the save block, the block staging task being deferred until the allocated block of non-volatile memory is no longer being accessed in response to another request for write access.

18. The method as claimed in claimed in claim 13, which includes activating a copy counter each time that new data is first received for a first write to any block of the production dataset since said point in time, activating the copy counter when the block staging task writes new data for any block of the production dataset to the production dataset, and deferring the creation of a new snapshot copy of the production dataset upon inspecting the copy counter and finding that the copy counter indicates that at least one block of new data has been received for writing to any block of the production dataset since said point in time and has not yet been written to the production dataset.

19. A server comprising:
storage for storing a production dataset; and
at least one processor for creating a snapshot copy of a production dataset concurrent with read-write client access to the production dataset, the snapshot copy being the state of the production dataset at a certain point in time;
said at least one processor being programmed for:
(a) keeping a record of blocks of the production dataset that have been modified since said point in time; and
(b) responding to a request from a client for write access to a specified block in the production dataset by checking said record of blocks of the production dataset that have been modified since said point in time and finding that the specified block in the production dataset has not been modified since said point in time, and upon finding that the specified block in the production dataset has not been modified since said point in time, allocating a block of non-volatile memory to the specified block and writing new data for the specified block from the client to the allocated block of non-volatile memory and returning an acknowledgement of completion of the write operation to the client, and thereafter a background copy process copying original data from the specified block of the production dataset to a save block allocated to the specified block and then initiating a block staging task for copying the new data for the specified block from the allocated block of non-volatile memory to the production dataset.

20. The server as claimed in claim 19, wherein said at least one processor is programmed for queuing another request for client write access to the specified block in a respective queue for the specified block when the new data for the specified block is being written to the staging block.

21. The server as claimed in claim 19, wherein said storage includes disk storage, and said at least one processor is programmed for storing the specified block of the production dataset and the save block in the disk storage, and initiating the copying of the original data from the specified block of the production dataset to the save block by sending a disk copy command to the disk storage.

22. The server as claimed in claim 19, wherein said storage includes a redundant disk array for storing the specified block of the production dataset and the save block, and wherein the copying of the original data from the specified block of the production dataset to the save block includes reading the original data from the specified block of the production dataset concurrent with reading original data from the save block and reading original parity associated with the original data read from the save block.

23. The server as claimed in claim 19, wherein said at least one processor is programmed for deferring the block staging task for the specified block when the allocated block of non-volatile memory is being accessed in response to another request for write access to the specified block at the time of completion of the copying of the original data from the specified block of the production dataset to the save block, the block staging task being deferred until the allocated block of non-volatile memory is no longer being accessed in response to another request for write access to the specified block.

24. The server as claimed in claimed in claim 19, wherein said at least one processor is programmed for activating a copy counter each time that new data is first received for a first write to any block of the production dataset since said point in time, activating the copy counter when the block staging task writes new data for any block of the production dataset to the production dataset, and deferring the creation of a new snapshot copy of the production dataset upon inspecting the copy counter and finding that the copy counter indicates that at least one block of new data has been received for writing to any block of the production dataset since said point in time and has not yet been written to the production dataset.
